(19) United States
(12) Patent Application Publication
(10) Pub. No.: US 2008/0148503 A1
(43) Pub. Date: Jun. 26, 2008

(54) Cable feeding device with indicator

(75) Inventors: Larry F. Babb, Grafton, OH (US); Clifford P. Duff, Sheffield Village, OH (US); Michael J. Rutkowski, Brunswick, OH (US)

Correspondence Address: RANKIN, HILL & CLARK LLP, 38210 Glenn Avenue, WILLOUGHBY, OH, 44094-7808, US

(73) Assignee: Emerson Electric Co.

(21) Appl. No.: 11/643,139

(22) Filed: Dec. 21, 2006

(51) Int. Cl. B08B 9/027

(52) U.S. Cl. 15/104.33

(57) ABSTRACT

A monitoring assembly for indicating the length of a sewer drain cleaning snake or flexible cable is described. The assembly provides a visual indication as to the length of cable that has been administered from, or retracted into, a sewer or drain cleaning device. The assembly is particularly adapted for use in hand held cleaning devices.

### BACKGROUND

The present invention relates to sewer cleaning machines and, more particularly, to improvements in sewer cleaning machines of the type having a flexible plumbers cable or snake coiled within a rotatable drum from which the snake is withdrawn and inserted into a pipe or sewer to be cleaned and by which the snake is rotated to achieve such cleaning.

Drum type sewer cleaning machines of the type to which the present invention is directed are well known and are shown, for example, in U.S. Pat. No. 2,468,490 to DiJoseph; U.S. Pat. No. 2,730,740 to O'Brien; U.S. Pat. No. 3,007,186 to Olsson; U.S. Pat. No. 3,394,422 to Siegal; U.S. Pat. No. 3,095,592 to Hunt; U.S. Pat. No. 3,134,119 to Criscuolo; U.S. Pat. No. 3,246,354 to Cooney et al.; U.S. Pat. No. 4,364,139 to Babb et al.; U.S. Pat. No. 4,580,306 to Irwin; U.S. Pat. No. 5,031,276 to Babb et al.; and U.S. Pat. No. 6,009,588 to Rutkowski, all of which are hereby incorporated by reference. As will be seen from these patents, it is known to provide a drum type sewer cleaning machine comprising a frame structure supporting the rotatable snake drum and a drive motor arrangement for rotating the drum, and to provide for the drum to be removable from the frame and drive arrangement to, for example, facilitate replacement of the drum with one containing a snake having a different diameter. It will also be seen from these prior art patents that such drum type sewer cleaning machines may include a snake feeding arrangement supported by the frame and by which the snake or cable is adapted to be axially displaced relative to the drum during use of the machine.

The present invention also relates to the art of drain cleaning tools and, more particularly, to cable feeding devices for hand held and hand operated drain cleaning tools. Hand held drain cleaning devices are also known in the art, such as U.S. Pat. No. 6,158,076 to Rutkowski et al., herein incorporated by reference. These hand held devices using a snake or other helically wound flexible member, typically include a drum that may be rotated to thereby advance or retract the snake from the device. Typically, these devices are adapted to engage with a powered tool such as an electric drill to thereby rotate the drum in the desired manner. As the drum is rotated to thereby dispense or retract the snake, rotation is imparted to the snake. That is, as the snake is linearly displaced from or to the drum, it is also undergoing rotation about its longitudinal axis. This is beneficial as such rotation promotes the ability of the snake to travel through conduits and piping, and assists in disrupting or breaking apart blockages in the conduit or piping.

Devices for monitoring the length of cable or rod material paid out from a sewer or drain cleaning machine are also known in the art, such as noted in U.S. Pat. No. 3,394,422 to Siegal and U.S. Pat. No. 5,009,242 to Prange, hereby incorporated by reference. Both of these patents are directed to measuring the length of a cable displaced into a drain being cleaned. However, in these applications, the cable material in the sewer cleaning device is not rotated about its axis, and is not in the form of a helically wound snake. Thus, these devices do not encounter the same problems as are encountered in connection with monitoring the displacement of such a rotating snake coiled inside a rotating drum.

Accordingly, there is a need for an assembly adapted for use in a sewer cleaning machine, and particularly, a hand held drain cleaning device that readily monitors the length or amount of a coiled snake that is displaced from or to a rotating drum.

### SUMMARY

The present invention provides, in a first aspect, a drain cleaning apparatus comprising a housing for supporting a drain cleaning cable having a forward end relative to the housing. The cable is displaceable forwardly relative to the housing for inserting the forward end of the cable into a drain to be cleaned. The drain cleaning apparatus also comprises a means for monitoring the forward displacement of the cable relative to the support.

In another aspect, the present invention provides a drain cleaning apparatus comprising a cable drum rotatable about a drum axis and having an opening, a drain cleaning cable coiled in the drum and rotatable therewith, a cable guide in the drum and rotatable therewith and relative thereto about the axis, and a means for monitoring the rotational displacement of the guide relative to the drum. The cable has a forward end extending through the opening for insertion into a drain to be cleaned and displacement of the cable forwardly of the opening causes the cable guide to rotate relative to the. drum.

In yet another aspect, the present invention provides a cable feeding device with an indicator. The device comprises a housing defining a nose adapted to receive a flexible cable passing therethrough and a generally hollow interior serving to retain the cable in a coiled configuration. The device also comprises a rotatable guide tube defining a passage adapted to receive the cable passing therethrough. The guide tube is threadedly engaged with the housing such that upon rotation of the guide tube relative to the housing, the guide tube is linearly displaced, thereby providing indication as to the amount of cable having passed through the guide tube.

In yet another aspect, the present invention provides a cable feeding device with an indicator. The device comprises a housing defining an opening adapted to receive a flexible cable passing therethrough, and a generally hollow interior for retaining the cable in a coiled configuration. The device also comprises a rotatable guide cone disposed within the interior of the housing. The guide cone defines a threaded channel extending through at least a portion of the guide cone and extending centrally along an axis of rotation of the guide cone. The guide cone also defines a receiving passage adapted to accommodate the cable passing therethrough. The device also comprises a scale piston at least partially disposed within the channel defined in the guide cone. The scale piston is threadably engaged with the threaded channel of the guide cone. The scale piston slidably extends through an aperture defined in a rear face of the housing, such that upon rotation of the guide cone, relative to the housing, the scale piston is linearly displaced with respect to the housing.

### BRIEF DESCRIPTION OF THE DRAWINGS

The present invention may take physical form in certain parts and arrangements of parts, and preferred embodiments of which will be described in detail in this specification and illustrated in the accompanying drawings which form a part hereof and wherein:

FIG. 1 is a partial cross-sectional view of a first preferred embodiment cable feeding device with a cable feed indicator.

FIG. 2 is a top planar view of the preferred embodiment cable feeding device shown in FIG. 1 with a cable feed indicator.

FIG. 3 is a detailed view of the indicator region of the cable feeding device in FIGS. 1 and 2.

FIG. 4 is a schematic representation of an interior assembly of the cable feeding device.

FIG. 5 is a schematic representation of the operation of the assembly depicted in FIG. 4.

FIG. 6 is a detailed view of the indicator region of the cable feeding device depicted in FIGS. 4 and 5.

FIG. 7 is a partial cross-sectional view of a second preferred embodiment cable feeding device with a cable feed indicator.

FIG. 8 is a perspective cut-away view of the device shown in FIG. 7, revealing the interior of the device.

### DETAILED DESCRIPTION

The preferred embodiment devices described herein generally comprise a housing and particularly a drum, for supporting or otherwise retaining a drain cleaning cable or plumbers snake. The cable includes a forwardmost end that is adapted for insertion into a drain to be cleaned, or other application. The embodiments feature a cable guide that is generally rotatable with respect to a central axis of the housing and/or drum. The cable guide rotates based upon the linear displacement of the cable as it is dispensed from, or retracted into, the housing. The amount or extent of rotation of the cable guide induces linear movement in an indicator member, thereby providing a visual indication of the length of cable that has been dispensed or retracted. In the two preferred embodiments described herein, the cable guide is in the form of a guide tube, and in the other embodiment, in the form of a guide cone. However, a wide array of other forms and configurations are contemplated for the cable guide.

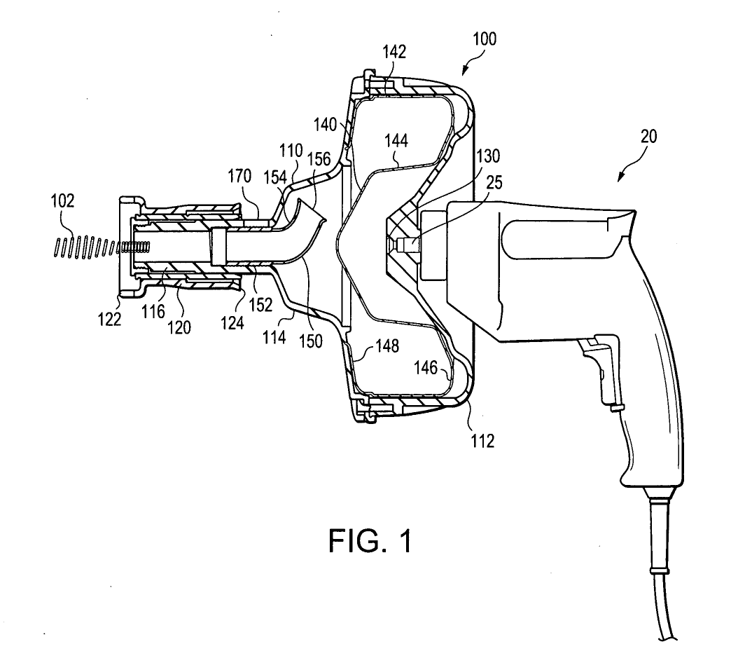

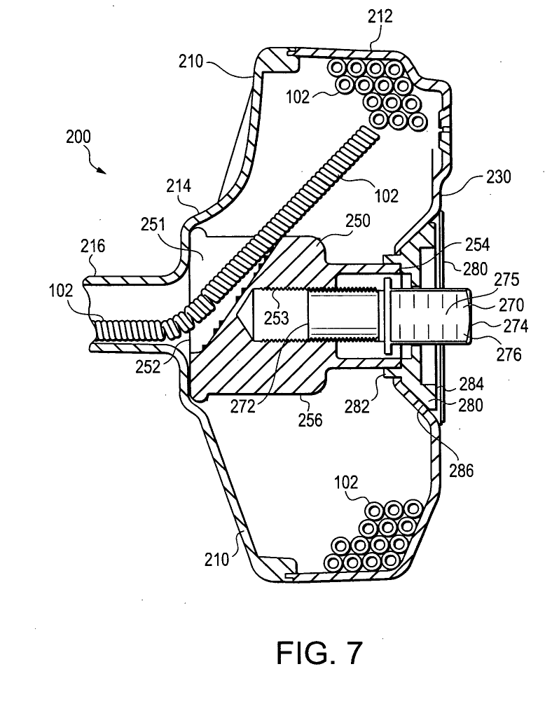

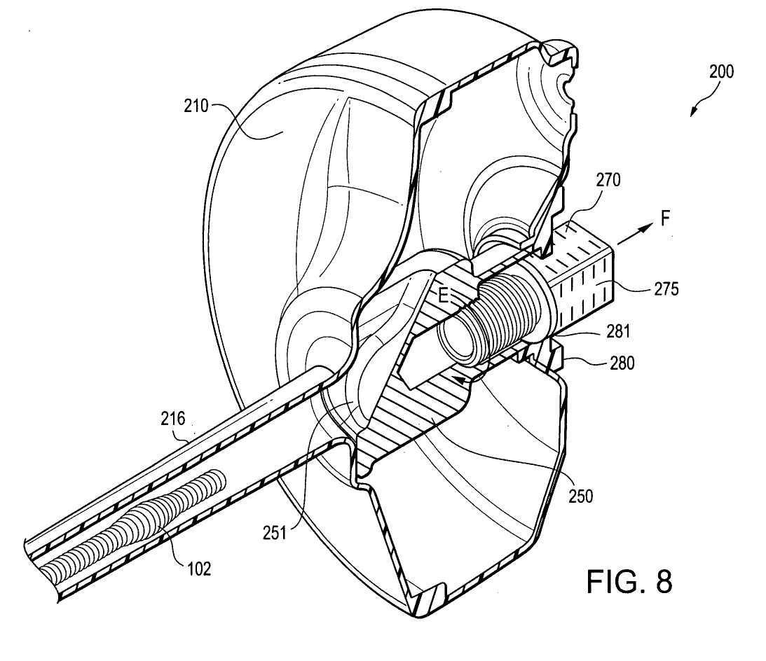

Referring now in greater detail to the drawings, wherein the showings are for the purpose of illustrating preferred embodiments of the invention only, and not for the purpose of limiting the invention, FIGS. 1-6 illustrate a preferred embodiment cable feeding device 100 having a cable feed indicator. FIGS. 7 and 8 illustrate another preferred embodiment cable feeding device 200 having a cable feed indicator.

Specifically, referring to FIG. 1, the preferred embodiment cable feeding device 100 having a cable feed indicator preferably engages and is powered by a drill 20 or other source of rotary power. The cable feeding device 100 comprises a housing 110, a rotatable collar 120, an engagement region 130 located at the rear of the housing 110, a cable storage member 140 disposed within the interior of the housing 110, a hollow guide tube 150 also retained within the interior of the housing 110, and an indicator region 170, all of which are explained in greater detail herein. The drill 20 is engaged to the device 100 along the engagement region 130 and specifically, at receptacle 25 disposed along the rear of the housing 110 and at the axis of rotation of the housing 110. The cable feeding device 100 as explained herein, provides for storage, dispensing, and retraction of a flexible cable 102 or snake as known in the art. During operation of the device 100, an operator typically grips the drill 20 with one hand, and grips the collar 120 with his or her other hand. The drill rotates the housing 110 to facilitate dispensing or retracting the flexible cable 102 or snake. Alternately, the housing or drum of the device 100 can be rotated by hand or by a belt driven powered assembly. Although it is generally preferred to rotate the housing or drum to administer or retract the cable 102 with respect to the device 100, it is also possible to manually dispense or retract the cable 102 with respect to the device 100.

The housing 110 includes a drum 112 defined along the rear region of the housing 110, a nose 116 defined along the frontward region of the housing 110, and a dispensing region 114 extending between the drum 112 and the nose 116. The cable storage member 140 is preferably located within the interior of the housing 110 and preferably within the interior of the drum 112. The cable storage member 140 includes an outer circumferential wall 142, an inner circumferential wall 144, and a rear wall 146 extending between the outer wall 142 and the inner wall 144. Preferably, a front wall 148 is also provided extending radially inward from the outer wall 142, and preferably positioned opposite from and facing the rear wall 146. It is contemplated that the device 100 may be formed so that the device is free of the cable storage member 140. In this alternative version, the drum 112 of the housing serves to directly store and retain cable 102 coiled therein.

The guide tube 150 receives the flexible cable 102 or snake, and is rotatably positioned within the interior of the housing 110 and preferably within the dispensing region 114. The guide tube 150 includes a threaded region 152, an angled region 154, and a free end 156. Preferably, the threaded region 152 includes threads defined along an outer surface of the tube 150 within that region. The guide tube 150 is generally in the form of a hollow cylindrical member having a rearwardly defined curved or arcuately extending end portion, such as the free end 156. Preferably, the frontward region of the guide tube 150 such as the threaded region 152 is rotatably engaged with the housing 110, and preferably along an interior surface of the dispensing region 114. As explained in greater detail herein, preferably, corresponding threads are provided along the interior surface of the dispensing region 114 to engage the threads within the threaded region 152 and along the outer surface of the guide tube 150.

The collar 120 is rotatable with respect to the housing 110. The collar is generally in the form of a hollow cylindrical member and defines a forward end 122 and a rearward end 124. The collar 120 is sized and positioned generally about the frontward portion of the nose 116. The collar 120 is rotatably secured to the nose 116 or other portion of the housing 110 so that the collar 120 is retained thereon yet rotatable. The collar 120 serves as a gripping region for an operator when using the device 100.

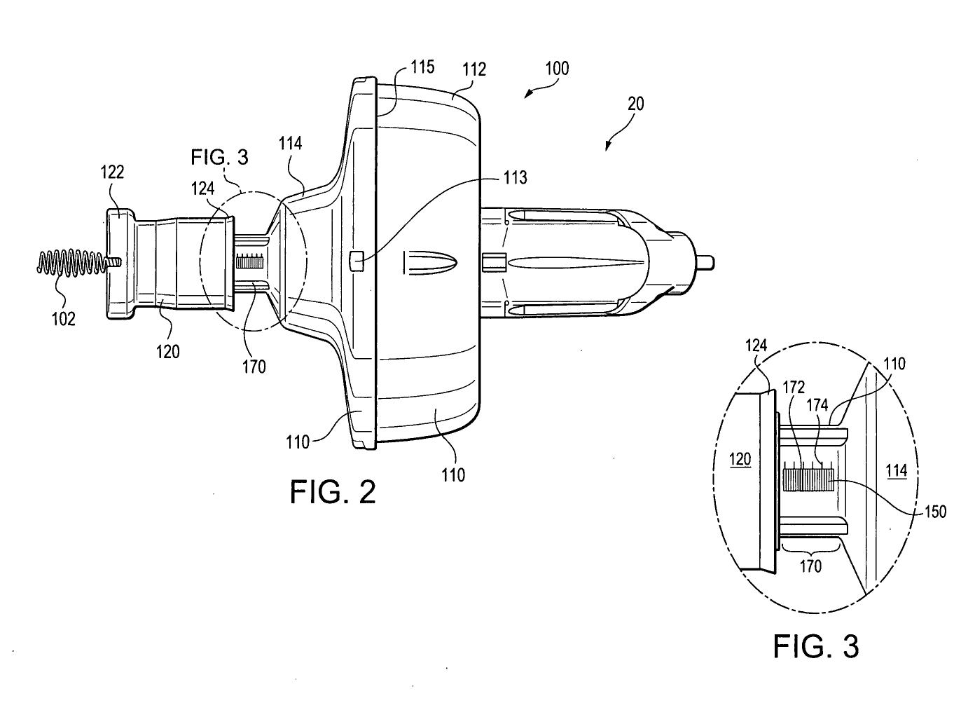

FIG. 2 illustrates a top planar view of the preferred embodiment cable feeding device 100 having the cable feed indicator in accordance with the present invention. It may in certain embodiments, be desirable to provide for the housing 110 to be provided in two or more releasably engageable sections that can be opened such as along a circumferential edge 115. The sections can be releasably engaged to one another by the use of flexible retaining members 113, for example. As previously noted, the device 100 is preferably releasably engaged to a powered drill 20. Preferably, an indicator region 170 is defined along the top region of the indicator 100 and preferably between the dispensing region 114 and the nose 116. The indicator region 170 may be in the form of a window or other opening defined in the housing 110 such that a portion of the guide tube 150 is exposed therethrough or is visible. The indicator region 170 may utilize an aperture or other opening defining in the housing 110 that enables the relevant portion of the guide tube 150 to be seen therethrough. Alternately, the indicator region 170 may include a transparent or generally so cover plate or window enabling the portion of the guide tube 150 to be viewable therethrough.

FIG. 3 is a detailed view of the indicator region 170 revealing an indication line or other demarcation 172 defined along the outer surface of the guide tube 150 and viewable through the indicator region 170. A scale or other marking 174 is preferably provided along the outer surface of the housing 110, and preferably within one or both of the regions of the nose 116 (not visible) and the dispensing region 114 of the housing 110. The operation of the indicator is as follows.

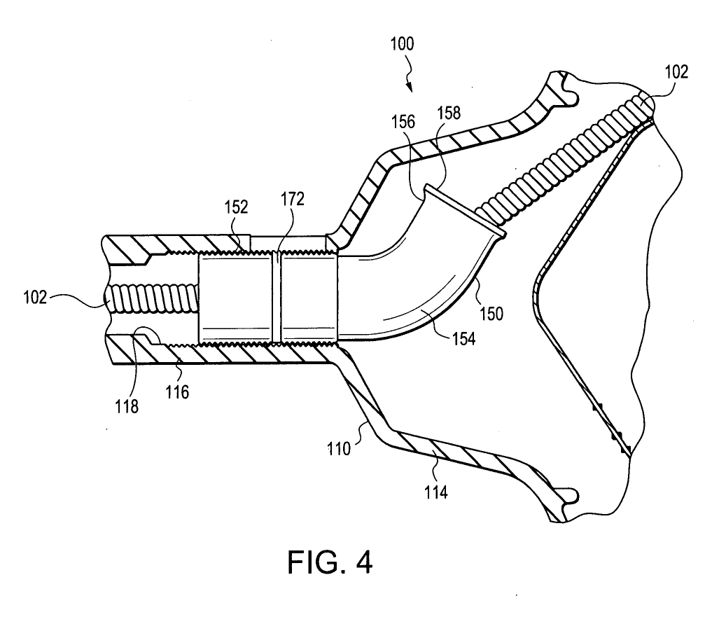

FIG. 4 is a detailed partial cross-sectional view of the interior of the housing 110 of the preferred embodiment cable feeding device 100 having the cable feed indicator. FIG. 4 more specifically illustrates the relationship and configuration of the guide tube 150 with respect to the housing 110. Preferably, the guide tube 150 may include a flared or outwardly extending lip 158 along its free end 156. As shown in FIG. 4, the cable 102 preferably extends through the guide tube 150. The cable 102 is generally of the snake type as known in the art, and is preferably, a helically wound cable. The guide tube 150 preferably defines a threaded region 152 extending along a forward region and outer surface of the guide tube 150. That threaded region 152 is preferably in threaded engagement with a corresponding set of threads defined along an interior circumferential wall 118 of the nose 116 of the housing 110. Upon rotation of the housing 110 and the drum 112 (not shown), such as by powered rotation by a drill 20 or other tool engaged thereto, the cable 102 is either linearly dispensed from the housing and drum or retracted into the housing and drum, through the nose 116 and thus, through the guide tube 150. As the cable 102 travels between the interior of the housing and drum, at which the cable 102 is in a coiled arrangement, and the nose 116, the guide tube 150 is rotated. As the cable 102 is coiled or uncoiled, the guide tube 150 rotates corresponding to the extent of that coiling or uncoiling. The extent of rotation of the guide tube 150 is independent of the rotation of the housing 110 or drum 112. Upon rotation of the guide tube 150 with respect to the housing 110, the guide tube 150 is linearly translated between the forward and rearward portions of the housing 110 due to the threaded engagement between the guide tube 150 and the nose 116. More specifically, as the guide tube 150 is rotated relative to the housing 110, the relative linear position of the indicator line 172 moves with respect to the nose portion 116 of the housing 110. Therefore, the extent of rotation of the guide tube 150 is indicated by the change in linear position of the indicator line 172, with respect to the housing 110. The change in linear position of the indicator line 172 provides an indication as to the length of the cable 102 paid out or retracted into the device 100.

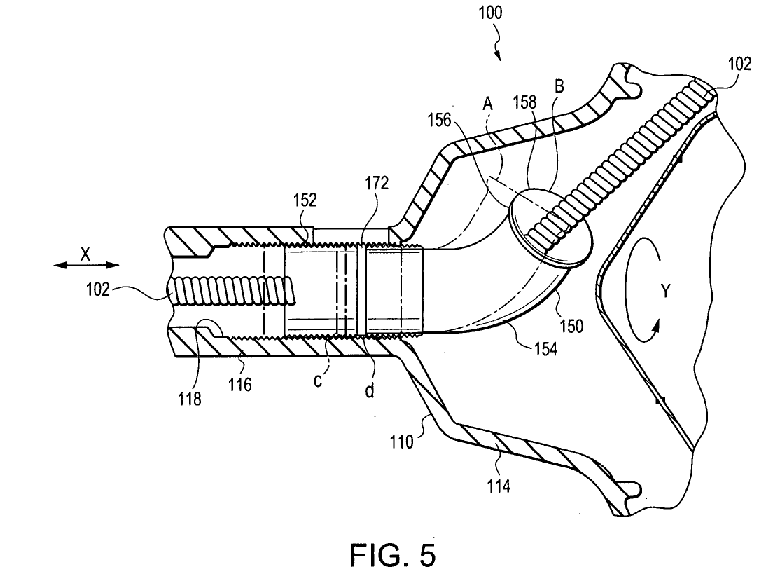

FIG. 5 further illustrates operation of the preferred embodiment cable feed indicator as incorporated and used in the preferred embodiment cable feeding device 100. During operation, the cable or snake 102 is displaced in either a forward or rearward direction as indicated by arrow X. This, in turn, results in rotation or partial rotation of the guide tube 150 as shown by arrow Y. As the guide tube 150 rotates, it is displaced from a previous position designated by “A” to a new position designated as position “B.” This rotational displacement from A to B translates to a linear displacement of the indicator line 172 from a previous position “c” to a new position “d.” Thus, it will be appreciated that as the cable 102 is either dispensed from or retracted into the housing 110 of the cable feeding device 100, the guide tube 150 rotates or partially rotates which in turn results in linear displacement of the guide tube 150 and thus indicator line 172 with respect to the housing 110.

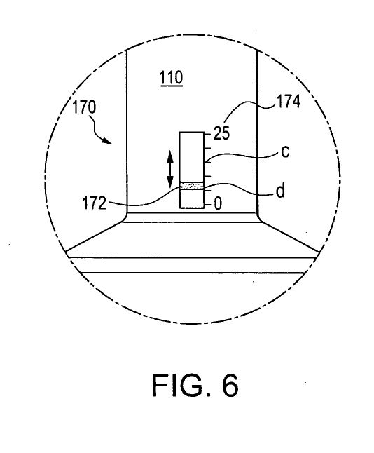

FIG. 6 is a detailed view of the indicator region 170 showing in greater detail, the change in position of the indicator line 172, from previous position “c” to new position “d.”

FIG. 7 is a partial cross-sectional view of another preferred embodiment cable feeding device 200 having a cable feed indicator in accordance with the present invention. The device 200 is adapted for dispensing and retaining a cable 102 or snake, and storing the cable in a wound or coiled configuration within its interior. The housing of this device can rotate or remain stationary during dispensing or retraction of the snake or cable. The device 200 is similar in certain respects to the previously described device 100, however does not require a drill or other powered tool to rotate the housing. Instead, an outwardly extending handle or knob (not shown) can be provided along the rear portion of the device 200. An operator or user of the device can grip a rotatable front collar (not shown) similar to collar 116 as used in device 100, and then with another hand, grasp the knob and rotate the device 200. Alternately, the housing or drum of the device 200 can be rotated by a belt driven powered assembly. Or, as noted, the housing may remain stationary while a cable feed assembly is used to dispense or retract the cable or snake. Alternatively, a user may simply administer or retract the cable manually.

The device 200 comprises a housing 210 including a drum 212, a nose 216, and a dispensing region 214 extending between the drum 212 and the nose 216. A rear face region 230 is defined along the rear face of the drum 212. Preferably, the housing 210 is an integral, one-piece unit that includes the drum 212, the nose 216, and the regions 214 and 230. However, the invention includes multi-component housings. The cable feeding device 200 also includes a rotatable guide cone 250 rotatably mounted within the interior of the housing 210. The guide cone 250 is rotatable with respect to the housing 210. The guide cone 250 includes a front face 252, an oppositely directed rear portion 254, and an outer circumferential surface 256 extending between the front face 252 and the rear portion 254. The guide cone 250 also defines a passage or slot 251 adapted to receive and promote passage of the snake 102 through the guide cone 250. The cable feeding device 200 also comprises a rear support member 280 that provides a frontwardly disposed circular race 282 which provides support and guidance for the guide cone 250 rotatably disposed therein. The rear support 280 also defines a rear face 284 and a tapered outer surface 286 extending between the race 282 of the support member 280 and the rear face 284. Preferably, the outer surface 286 is secured to or otherwise joined to the outer surface of the region of the drum 212 at that location so as to form a generally enclosed interior for storage of the cable 102. Also included in the interior of the cable feeding device 200 is a scale piston 270. The scale piston 270 includes a front region 272, a rear region 274, and an outer surface 276 extending therebetween. Defined along an outer surface of the front region 272 of the scale piston 270 are a plurality of threads. Corresponding threads are defined along an interior surface of a channel 253 defined in the midsection of the guide cone 250. The outer surface 276 of the scale piston 270 includes a scale 275 or other indicia or markings. The scale piston 270 is slidably received by, or otherwise partially engaged with the rear support 280. That is, the scale piston 270 is linearly displaceable with respect to the housing 210 and rear support 280. The scale piston 270 cannot rotate relative to the housing 210 because the piston is keyed or otherwise coupled with the rear support 280. As noted, the scale piston 270 can rotate relative to the guide cone 250 in view of their threaded engagement, which as will be appreciated, will result in linear displacement of the scale piston 270. Upon dispensing or retraction of the cable or snake 102 from or into the housing 210 and specifically, the drum 212, the guide cone 250 rotates. As previously explained, rotation of the guide cone 250 occurs, since the guide cone “follows” the winding or unwinding of the cable 102. The threaded engagement between the guide cone 250 and the scale piston 270 causes linear displacement of the scale piston 270 relative to the guide cone 250 and the housing 210, upon rotation of the guide cone 250.

FIG. 8 is a perspective partial cut-away view of the preferred embodiment cable feeding device 200 with a cable feed indicator. The device 200 includes the rotatable guide cone 250 rotatably disposed within the interior of the housing 210. As noted, the guide cone 250 defines a slot 251 or other region through which the cable or snake 201 extends. As will be appreciated, as the snake 102 is either wound from or into the housing 210, the guide cone 250 rotates, or at least partially rotates. As the guide cone rotates, such as in the direction of arrow E, the scale piston 270 is linearly displaced in the direction of arrow F. The scale piston 270 is precluded from rotating with the guide cone 250 with which it is threadably engaged due to a square retention aperture 281 defined along the rear support 280. The present invention includes the use of other structures and assemblies to preclude rotation of the scale piston 270 with respect to the guide cone 250.

Regarding both preferred embodiment devices 100 and 200, the extent of linear displacement of the guide tube 150 in device 100, and that of the scale piston 270 in device 200, depends upon the thread configuration utilized in conjunction with those components. Preferably, the thread configuration used can be either right handed or left handed. A wide range of thread pitches can be used.

The following examples illustrate the relationship between the thread configuration used on the guide tube or guide cone, and the length of the scale. These examples are merely representative and in no way limit the present invention.

### EXAMPLE 1

In a cable feeding device as described herein, in order to designate the length of snake cable advanced or retracted from the device using (i) 25 feet of snake cable, (ii) a 6.5 inch diameter drum, and a thread pitch of 16 threads per inch on the guide tube or guide cone, the scale is preferably about 1.125 inches in length.

### EXAMPLE 2

In a cable feeding device as described herein, in order to designate the length of snake cable advanced or retracted from the device using (i) 25 feet of snake cable, (ii) a 6.5 inch diameter drum, and a thread pitch of 18 threads per inch on the guide tube or guide cone, the scale is preferably about 1.00 inches in length.

### EXAMPLE 3

In a cable feeding device as described herein, in order to designate the length of snake cable advanced or retracted from the device using (i) 25 feet of snake cable, (ii) a 6.5 inch diameter drum, and a thread pitch of 20 threads per inch on the guide tube or guide cone, the scale is preferably about 0.90 inches in length.

It will be understood that the assemblies described and illustrated herein provide an indication as to the length of cable or snake dispensed or retracted based upon the rotational differential between (i) an interior member such as the guide tube 150 or the guide cone 250, that rotates based upon the formation or removal of windings or coiling of the snake within the interior of the device, and (ii) the rotation of the housing or drum of the device. That is, the indicators described herein are based upon the relative rotation between the interior member and the housing or drum. Thus, the indicators described herein can be used in devices in which (i) the cable or snake is dispensed or retracted as a result of rotating the housing, such as with a drum, (ii) in devices in which the cable or snake is dispensed from or retracted into the housing manually or by use of an ancillary cable feeding mechanism, or (iii) in devices in which the cable or snake is dispensed from or retracted into the housing, while the drum or housing remains stationary.

While considerable emphasis has been placed herein on the structures and structural interrelationships between the component parts of the embodiments disclosed, it will be appreciated that other embodiments of the invention can be made and that many changes can be made in the embodiments illustrated and described without departing from the principles of the invention. Accordingly, it is to be distinctly understood that the foregoing descriptive matter is to be interpreted merely as illustrative of the present invention and not as a limitation.

Having thus described the invention, it is so claimed:

1. A drain cleaning apparatus comprising a housing for supporting a drain cleaning cable having a forward end relative to the housing, the cable being displaceable forwardly relative to the housing for inserting the forward end into a drain to be cleaned, and means for monitoring the forward displacement of the cable relative to the support.

2. The drain cleaning apparatus according to claim 1, wherein the housing includes a cable drum having an opening, the drain cleaning cable being coiled in the drum and the forward end extending through the opening, and the means for monitoring include measuring the length of cable withdrawn through the opening.

3. The drain cleaning apparatus according to claim 1, wherein the housing includes a cable drum rotatable about a drum axis, the cable being coiled in the drum, a cable guide rotatable about the axis with and relative to the drum, the forward end of the cable extending through the cable guide, and said means for monitoring include measuring rotational displacement of the cable guide relative to the drum.

4. The drain cleaning apparatus according to claim 3, wherein the cable guide is selected from a guide tube and a guide cone.

5. A drain cleaning apparatus comprising a cable drum rotatable about a drum axis and having an opening, a drain cleaning cable coiled in the drum and rotatable therewith, a cable guide in the drum and rotatable therewith and relative thereto about the axis, the cable having a forward end extending through the opening for insertion into a drain to be cleaned, displacement of the cable forwardly of the opening causing the cable guide to rotate relative to the drum, and means for monitoring the rotational displacement of the guide relative to the drum.

6. The drain cleaning apparatus of claim 5 wherein the cable guide is in the form of a rotatable guide tube threadedly engaged with the cable drum.

7. The drain cleaning apparatus of claim 6 wherein the cable drum defines a region through which the guide tube is visible.

8. The drain cleaning apparatus of claim 5 wherein the cable guide is in the form of a rotatable guide cone threadedly engaged with the cable drum.

9. The drain cleaning apparatus of claim 8 further comprising a scale piston slidably retained within an aperture defined in the drum, wherein the guide cone is threadedly engaged with the scale piston.

10. A cable feeding device with an indicator, the device comprising:
a housing defining a nose adapted to receive a flexible cable passing therethrough, and a generally hollow interior serving to retain the cable in a coiled configuration;
a rotatable guide tube defining a passage adapted to receive the cable passing therethrough, the guide tube being threadedly engaged with the housing such that upon rotation of the guide tube relative to the housing, the guide tube is linearly displaced, thereby providing an indication as to the amount of cable having passed through the guide tube.

11. The device of claim 10 wherein the housing defines a region adjacent the guide tube, wherein the guide tube is visible through the region.

12. The device of claim 10 wherein the guide tube is threadedly engaged by a first set of threads defined along an interior surface in the nose of the housing, and a second set of threads defined along an outer surface of the guide tube.

13. A cable feeding device with an indicator, the device comprising:
a housing defining an opening adapted to receive a flexible cable passing therethrough, and a generally hollow interior for retaining the cable in a coiled configuration;
a rotatable guide cone disposed within the interior of the housing, the guide cone defining a threaded channel extending through at least a portion of the guide cone and extending centrally along an axis of rotation of the guide cone, the guide cone also defining a receiving passage adapted to accommodate the cable passing therethrough;
a scale piston at least partially disposed within the channel defined in the guide cone, the scale piston threadably engaged with the threaded channel of the guide cone, the scale piston slidably extending through an aperture defined in a rear face of the housing, such that upon rotation of the guide cone, the scale piston is linearly displaced with respect to the housing.
